(19) United States
(12) Patent Application Publication
(10) Pub. No.: US 2002/0189740 A1
(43) Pub. Date: Dec. 19, 2002

(54) Methods and systems for making high density fiberboards from low density fibrous media

(76) Inventors: Neil A. Carter, Granville, OH (US); Gordon H. Hart, Indianapolis, IN (US); David Rhind, Greenfield, IN (US)

Correspondence Address: NIXON & VANDERHYE P.C., 8th Floor, 1100 North Glebe Road, Arlington, VA, 22201-4714, US

(21) Appl. No.: 09/883,262

(22) Filed: Jun. 19, 2001

(51) Int. Cl. B31D 1/00; D04H 1/00; B27N 3/00

(52) U.S. Cl. 156/62.2; 156/296; 264/109

(57) ABSTRACT

Methods and systems for making a fiberboard product having a desired final thickness dimension by subjecting a fibrous board preform to a successive series of compressive pressures. Preferably, an upstream one of the compressive pressures causes the board preform to exhibit a compressed thickness dimension which is less than the final thickness dimension of the fiberboard product, while a downstream one of the compressive pressures causes the board preform to exhibit a thickness dimension which is substantially the same as the final thickness dimension of the fiberboard product. Between subjecting the board preform to these upstream and downstream compressive pressures, the upstream one of the compressive pressures may be removed sufficiently to cause the compressed thickness dimension to increase to an intermediate thickness dimension which is less than the initial thickness dimension of the board preform, but is greater than the final thickness dimension of the fiberboard product. Most preferably, the upstream compressive pressure is accomplished by passing the board preform between and through a nip space defined between an opposed pair of rolls.

### FIELD OF THE INVENTION

The present invention generally relates to methods and systems for making relatively thick boards of fibrous materials. In preferred forms, the present invention relates to methods and systems for making inorganic fiber boards having a heat-curable binder dispersed throughout a mass of inorganic fibers.

### BACKGROUND AND SUMMARY OF THE INVENTION

Recently, systems and methods have been proposed in copending, commonly owned U.S. patent application Ser. No. 09/567,771 filed on May 9, 2000 (the entire content of which is expressly incorporated hereinto by reference) whereby relatively thick boards may be made from inorganic fibers, preferably fibers obtained from pre- or post-consumer waste fiberglass products (e.g., building insulation). In preferred embodiments, the systems and methods disclosed therein include forming a fiber-containing board at least about one inch thick and having at least 25% (and typically at least about 90%) by weight inorganic fibers (such as primarily recycled pre- or post-consumer waste glass fibers from fiberglass products, such as building insulation) that is dimensionally stable. In order to impart dimensional stability, a heat-curable binder solution (e.g., a solution containing a phenolic binder resin) is typically applied to the wet-laid fiber board preform. Thus, during production, the fiber board preform is transported through a heated curing oven where remaining residual water is removed from the board and the binder (which had been applied to the board preform upstream of the curing oven) is cured.

The fiber board preform is essentially supported between a pair of endless forming and transport conveyors as it moves through the curing oven. In addition, the opposed conveyors exert a compressive pressure on the fiber board preform so as to control the final thickness dimension of the finished fiber board—that is, to maintain a desired thickness of the board within the curing oven as the binder cures. Thus, as the fiber board preform dries and the binder cures, the opposed conveyors will compress the board to its final desired thickness during transport through the curing oven. It has been discovered, however, that a substantial amount of compressive pressure is needed in the curing oven in order to achieve the desired thickness dimension of the finished board which, in turn, demands that substantial (and costly) structural support must be provided for the forming and transport conveyors therein. Moreover, the conveyors of the curing oven may have a designed maximum compressive load which would limit the maximum bulk pack density for the board that could be obtained thereby.

It is therefore an object of the present invention to provide improvements to systems and methods for forming binder-containing inorganic fibrous boards. In this regard, it would highly be desirable if the compressive pressure exerted between the forming and transport conveyors of the curing oven could be reduced. It is towards fulfilling such a need that the present invention is directed.

Broadly, the present invention is embodied in methods and systems for making a fiberboard product having a desired final thickness dimension by subjecting a fibrous board preform to a successive series of compressive pressures. Preferably, an upstream one of the compressive pressures causes the board preform to exhibit a compressed thickness dimension which is less than the final thickness dimension of the fiberboard product, while a downstream one of the compressive pressures causes the board preform to exhibit a thickness dimension which is substantially the same as the final thickness dimension of the fiberboard product. Between subjecting the board preform to these upstream and downstream compressive pressures, the upstream one of the compressive pressures may be removed sufficiently to cause the compressed thickness dimension to increase to an intermediate thickness dimension which is less than the initial thickness dimension of the board preform, but is greater than the final thickness dimension of the fiberboard product. Most preferably, the upstream compressive pressure is accomplished by passing the board preform between and through a nip space defined between an opposed pair of rolls.

These and other aspects and advantages of the present invention will become more clear after careful consideration is given to the following detailed description of the preferred exemplary embodiments thereof which follow.

### BRIEF DESCRIPTION OF THE ACCOMPANYING DRAWINGS

Reference will hereinafter be made to the accompanying drawings wherein like reference numerals throughout the various figures denote like structural elements, and wherein,

FIG. 1 is a schematic elevational view of a crusher roll system and its principles of operation in accordance with the present invention;

FIG. 2 is a side elevation view, partly in section, showing one possible form of a crusher roll system which embodies the principles in accordance with the present invention shown in FIG. 1 upstream of a curing oven;

FIG. 3 is a perspective view of the crusher roll system depicted in FIG. 2;

FIG. 4 is a side elevational view of the crusher roll system depicted in FIG. 2; and

FIG. 5 are data plots of compressive pressure (CP) vs. bulk pack density which compares the effects of several exemplary pre-compressive pressure conditions of uncured pack material in accordance with the present invention to a non-pre-compressed uncured pack material.

### DETAILED DESCRIPTION OF THE INVENTION

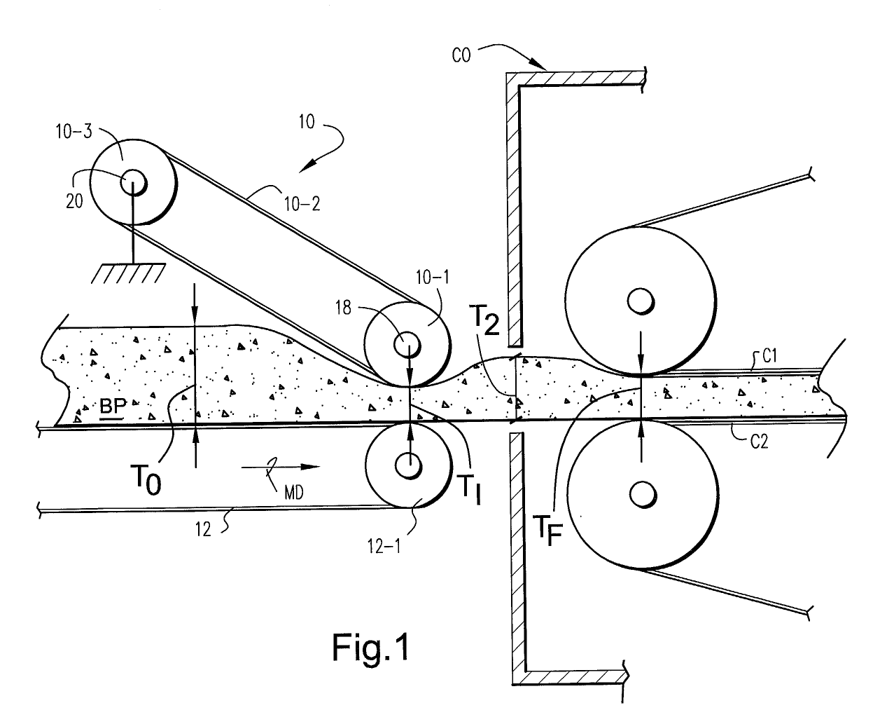

Accompanying FIG. 1 schematically depicts a crusher roll system 10 in accordance with the present invention position immediately upstream of a curing oven CO in which a pair of opposed forming and transport conveyors C1 and C2 are housed. As is shown, a board preform BP containing uncured binder dispersed therethrough is supported upstream of the curing oven by means of transport conveyor 12 and has an initial thickness dimension T₀ immediately prior to entering the nip space defined between the opposed rolls 10-1 and 12-1 associated with the crusher roll system 10 and the conveyor 12, respectively.

The crusher roll system 10 includes an endless forming member 10-2 which extends between the forward roll 10-1 and the rearward roll 10-3. As will be discussed in greater detail below, the rolls 10-1 and 10-2 are spaced apart generally in the machine (conveyance) direction MD. The rearward roll 10-3 is supported so as to be positionally stationary with respect to the forward roll 10-1.

The nip formed between the opposed rolls 10-1 and 12-1 associated with the crusher roll system 10 and the conveyor 12, respectively, thus compresses the thickness of the board preform form its initial or original thickness T₀ upstream of the crusher roll system 10 to a reduced thickness dimension T₁ which is less than the desired final dimension T_{F} which is maintained between the conveyors C1, C2 within the curing oven CO. These thickness dimensions therefore result in a density of the board preform BP subsequent to being subjected to the crusher roll system 10 which is greater as compared to the density of the board preform BP upstream thereof. However, immediately downstream of the nip formed between the opposed rolls 10-1 and 12-1, the thickness of the board preform BP will increase somewhat to a thickness dimension T₃ thereby allowing the density to somewhat decrease. This relaxation or increase of the thickness dimension (decrease in density) is due to the board preform BP no longer being subjected to the compressive pressure condition between the rolls 10-1 and 12-1 immediately downstream thereof, and since the board preform BP at that stage in the process includes uncured binder material.

It is noteworthy that the thickness of the board preform does not increase to its initial thickness T₀ immediately downstream of the crusher roll system 10. In this regard, it is surmised that, by compressing the thickness of the board preform to a thickness dimension T₁ which is less than the final desired thickness dimension T_{F}, the fibers in the board preform are caused to become irreversibly more tightly packed (i.e., so as to increase the density of the board preform) to an extent that the board preform will not again expand to its original thickness (density) once it has been compressed (“crushed”) between the opposed rolls 10-1 and 12-1. As a result, the compressive pressure needed to be exerted onto the board preform in the curing oven CO between the opposed conveyors C1, C2 (i.e., so as to compress the board thickness from its relaxed dimension T₂ to the final board thickness T_{F}) is substantially less as would have been required without the function of the crusher roll system 10 in accordance with the present invention.

By way of example, the natural density of a board preform BP comprised of glass fibers and uncured binder material is typically between about 2.5 to about 3.5 lbs/ft³, while the desired target density of an exemplary final board product (i.e., following curing of the binder in the curing oven CO) may be up to about 10.0 lbs/ft³. Without the presence of the crusher roll system 10 in accordance with the present invention, a compressive pressure condition of between, for example, about 120 to about 140 lbs/ft² would have to be exerted onto the board preform BP by means of the opposed conveyors C1, C2 to form a 7.0 lbs/ft density final product. This would thereby require costly supporting infrastructure within the curing oven CO. However, by using the crusher roll system 10 of the present invention, the amount of compressive pressure required to be exerted upon the board preform BP by means of the conveyors C1, C2 can be reduced dramatically to, for example, only about 80 lbs/ft² in order to achieve the same desired target density of about 7.0 lbs/ft³ (in this example) for the final board product.

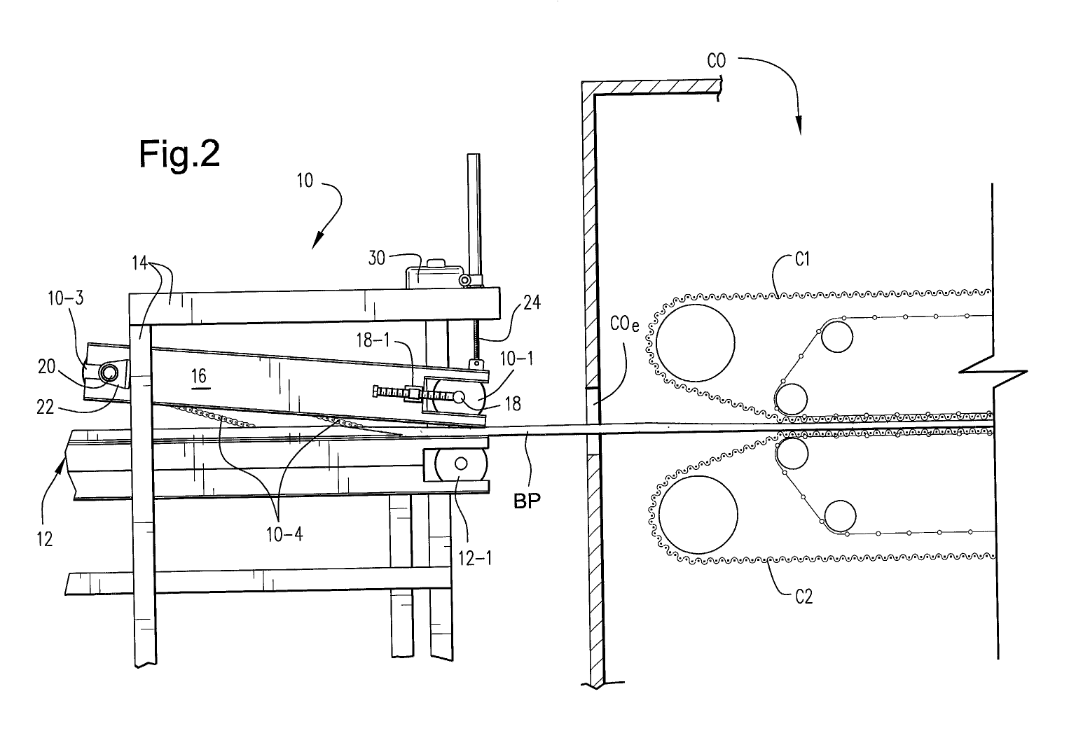

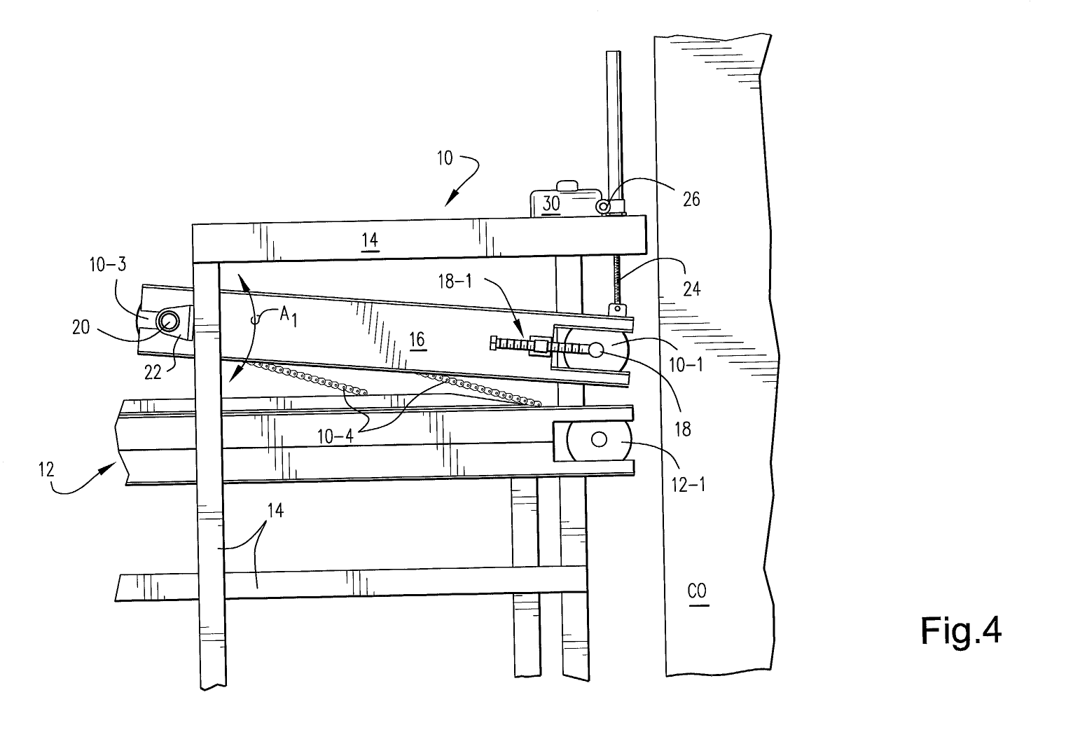

One particularly preferred embodiment of the crusher roll system 10 is depicted in accompanying FIGS. 2-4. As is seen, the crusher roll system 10 is positioned immediately upstream of the entrance COₑ of the curing oven CO so that the functions of the former may be realized on the board preform BP immediately prior to entering the latter. The crusher roll system 10 is generally supported by a rigid framework 14 at the downstream end of the conveyor assembly 12. The forward and rearward rolls 10-1 and 10-3, respectively, are supported by a pair of laterally (i.e., relative to the machine direction MD) support arms 16 so as to be spaced apart from one another generally in the machine (conveyance) direction MD (see FIG. 1). The forward roll 10-1 is mounted for rotational movements by means of a transverse axle 18. This axle 18 is, in turn, connected to a screw adjustment assembly 18-1 to allow for rectilinear movements of the roll 10-1 towards and away from the roll 10-3 and thereby permit the tension on the endless forming member 10-2 to be adjusted. The rolls 10-1, 10-3 are driven in a counterclockwise direction (as viewed in FIG. 2, for example) so as to encourage the board preform BP to be conveyed downstream to the curing oven. Any suitable drive means may be employed for such purpose, such as a drive motor (not shown) connected operatively to the rearward roll 10-3 via a conventional drive chain 10-4 (see FIGS. 2 and 4).

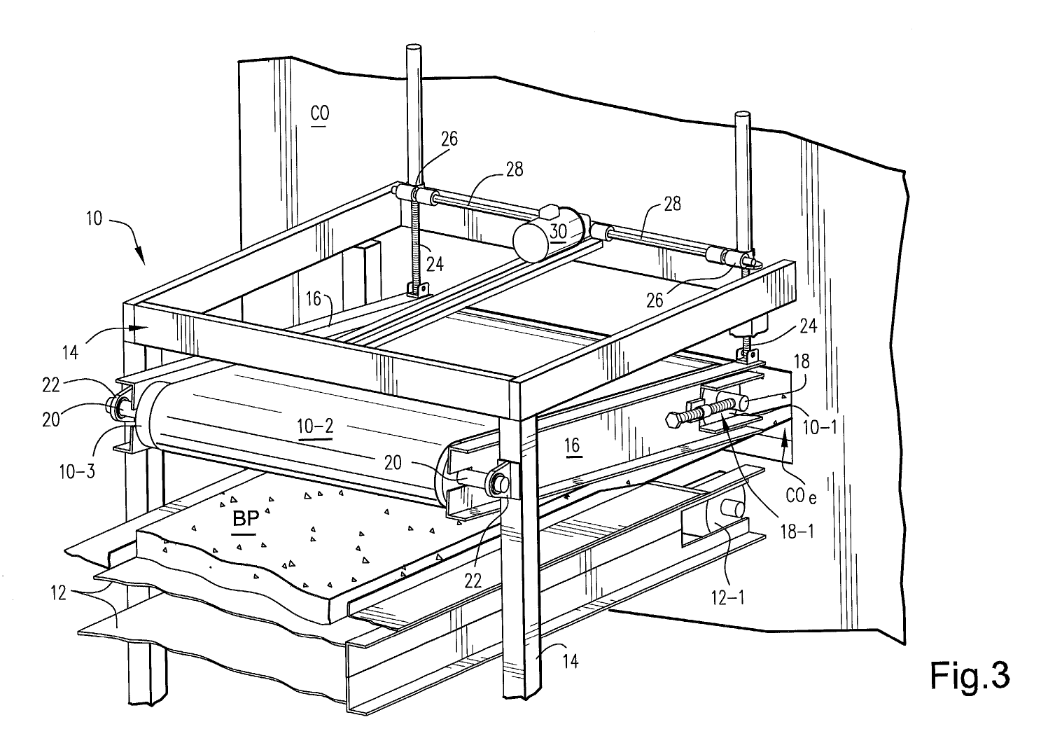

As is perhaps best seen in FIGS. 3 and 4, the rearward roll 10-3 is likewise mounted for rotational movements by means of a transverse axle 20 supported by, and extending between a pair of bearing blocks 22 fixed to the support structure 14. The bearing blocks 22 thereby also support the pair of arms 16 to allow for pivotal movements about the axis of axle 20 (arrow A₁ in FIG. 4). In such a manner, therefore, the nip dimension defined between the opposed rolls 10-1 and 12-1 may be altered to thereby alter the compressive pressure exerted on the board preform within that nip (i.e., so as to alter the thickness dimension T₁ to which the board preform BP is compressed by means of the rolls 10-1 and 12-1). Each forward end of the arms 16, and thus the forward roll 10-1, is supported dependently by means of a respective threaded support shaft 24 coupled operatively to a worm gear 26 at the terminal end of a drive shaft 28 extending from motor 30. Operation of the motor 30 will concurrently rotate each of the drive shafts 28 and the worm gears 26 which rotation, will in turn, threadably drive the support shafts 24 rectilinearly towards and away from the roll 12-1 (arrow A₂ in FIG. 3) depending on the direction of rotational movement. In such a manner, the forward end of the support arms 16 to which the shafts 24 are attached, and hence the roll 10-1 carried thereby, may be pivoted about the transverse axis established by the rear axle 20 (arrow A₁ in FIG. 4) to thereby adjust the nip dimension between the rolls 10-1 and 12-1.

The present invention will be further understood by reference to the following non-limiting Example.

### EXAMPLE

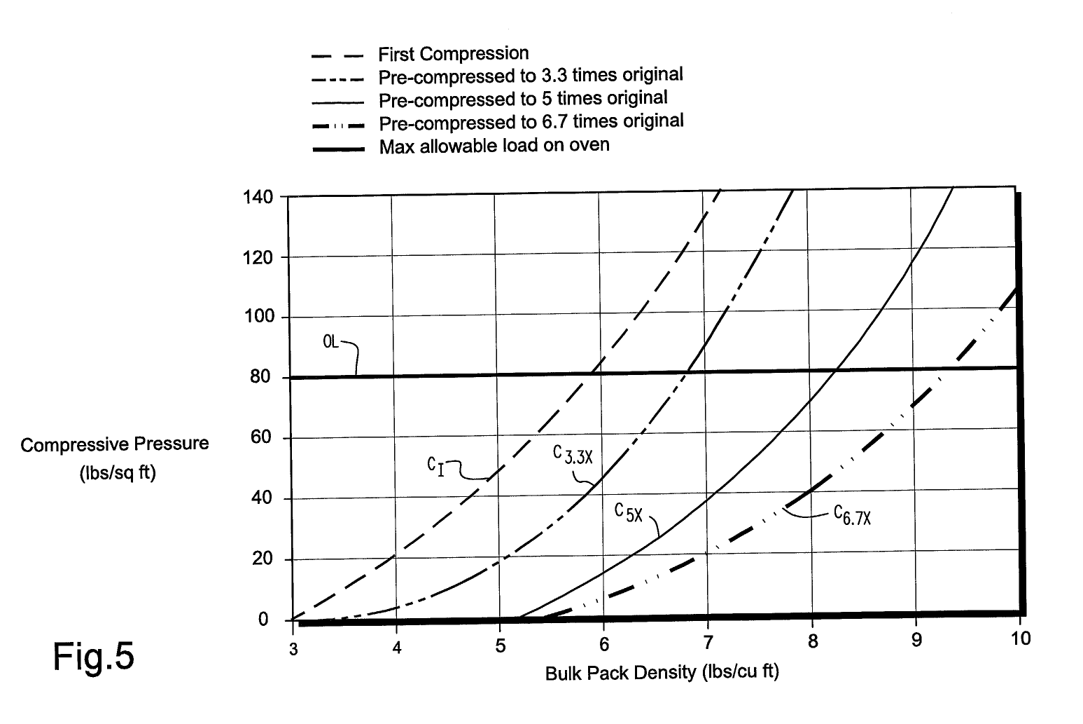

The present example will further explain the functional benefits of pre-compressing the uncured, moist fiberglass pack, prior to its entering the curing oven in accordance with the present invention. Specifically, in accompanying FIG. 5, curve Cₗ shows data representative of the relative initial compressive pressure (CP) vs. density relationship for a moist, uncured fiberglass pack in its first compression where the pack was formed at a bulk pack density of about 3 lbs/ft³. The maximum allowable pressure on the curing oven, which in this example was 80 lb/ft² is shown in FIG. 5 by the horizontal line OL which, as can be seen, crosses the curve Cₗ at about 6 lbs/ft³ density. By pre-compressing the uncured pack material, prior to its entering the curing oven, by 3.3 times (or stated another way, compressing the pack material to 3.3 times its original fiber bulk density) the CP vs. density curve (designated as curve C_{3.3×} in FIG. 5) shifted to the right, crossing line OL at a higher density of almost 7 lbs/ft³. Hence, this uncured fiberglass pack can be compressed by the curing oven to a higher density, using the same pressure, as compared to the density obtained at that compressive pressure, but in the absence of pre-compression by 3.3 times. Likewise, and to a greater effect, by pre-compressing the pack to 5 times and 6.7 times its original density, the CP vs. density curves C_{5×} and C_{6.7×}, respectively, shifted even further to the right as seen in FIG. 5. Specifically, it will be seen that pre-compression of the uncured pack material to 5 times resulted in curve C_{5×} crossing the maximum oven load OL line at a bulk pack density more than about 8.0 lbs/ft³, while curve C_{6.7×} crossed the maximum oven load OL at bulk pack density of more than 9 lbs/ft³, each of which is substantially greater than the original value of 6 lbs/ft³ for the material when not pre-compressed. In each successive case of greater pre-compression, therefore, the data of FIG. 5 show that the maximum density that can be attained in the curing oven, with its upper limit on line OL, was capable of being increased by pre-compressing the uncured moist fiberglass pack to a greater extent. Conversely, the data of FIG. 5 demonstrate that, in the absence of pre-compression on the uncured pack material in accordance with the present invention, the maximum attainable density in the curing oven was limited to that value corresponding to the intersection of curve Cₗ and the line OL.

It will, of course, be understood that the crusher roll system 10 described in detail above presently represents and especially preferred exemplary embodiment of the present invention. Various modifications and design changes may, however, be made without departing from the scope of the present invention. For example, in certain applications, the conveyor 10-2 and roll 10-3 may be omitted thereby providing for a roll serving similar functions as roll 10-1 described previously. In such a modified system, the crusher roll would include support structures to allow adjustability of the dimension Tₗ for a similar purpose as described above. Furthermore, the system 10 need not be driven by any motive means, but instead any roll(s) provided may be caused to rotate simply by virtue of the movement of the board preform in which the roll(s) is(are) in contact.

Therefore, while the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of making a fiberboard product having a desired final thickness and comprised of a mass of inorganic fibers and a cured binder material, which method comprises the steps of:
(a) subjecting a board preform comprised of a mass of inorganic fibers and an uncured binder material to a compressive pressure sufficient such that the board preform exhibits a compressed thickness which is less than a desired final thickness of the fiberboard product; and thereafter
(b) curing the binder material in the board preform while maintaining substantially the desired final thickness of the fiberboard product.

2. The method of claim 1, wherein after (a) there is practiced (a1) allowing the compressed thickness of the board preform to expand.

3. The method of claim 2, wherein step (a1) is practiced such that the expanded thickness of the board preform is greater than the final thickness of the board product, but less than an initial thickness of the board preform prior to step (a).

4. The method of claim 1, wherein step (a) is practiced by passing the board preform through a nip space defined between a pair of opposed rolls.

5. The method of claim 1, wherein step (b) is practiced by supporting the board preform between an opposed pair of conveyors so as to maintain said desired final thickness thereof.

6. A method of making a fiberboard product having a final thickness dimension comprising:
(a) collecting a mass of inorganic fibers to form a board preform having an initial thickness dimension greater than the final thickness dimension of the fiberboard product;
(b) subjecting the board preform of step (a) to a successive series of compressive forces which include (b1) an upstream one of the compressive forces which causes the board preform to exhibit a compressed thickness dimension which is less than the final thickness dimension of the fiberboard product, and (b2) a downstream one of the compressive forces which causes the board preform to exhibit a thickness dimension which is substantially the same as the final thickness dimension of the fiberboard product; and wherein
between steps (b1) and (b2) there is practiced the step of (b3) removing sufficiently the upstream one of the compressive forces to cause the compressed thickness dimension to increase to an intermediate thickness dimension which is less than the initial thickness dimension of the board preform prior to step (b), but is greater than the final thickness dimension of the fiberboard product.

7. The method of claim 6, wherein the board preform includes an uncured binder material, and wherein step (b2) is practiced so as to maintain substantially the final thickness dimension while curing the binder material.

8. The method of claim 7, wherein the binder material is heat-curable, and wherein step (b2) includes passing the board preform through a heated curing oven while maintaining substantially the final thickness dimension.

9. The method of claim 6, wherein step (b1) is practiced by passing the board preform through a nip space defined between a pair of opposed rolls which exert the upstream one of the compressive forces onto the board preform.

10. The method of claim 9, wherein step (b3) is practiced by removing the board preform from the nip space.

11. The method of claim 10, wherein step (b2) is practiced by supporting the board preform between an opposed pair of conveyors so as to maintain substantially said final thickness thereof.

12. The method of claim 11, wherein the board preform includes an uncured binder material, and wherein step (b2) is practiced so as to maintain substantially the final thickness dimension while curing the binder material.

13. The method of claim 12, wherein the binder material is heat-curable, and wherein step (b2) includes passing the board preform through a heated curing oven while maintaining substantially the final thickness dimension.

14. A system for making a fiberboard product having a desired final thickness and comprised of a mass of inorganic fibers and a cured binder material, comprising:
(a) a crushing system which subjects a board preform comprised of a mass of inorganic fibers and an uncured binder material to a compressive force sufficient such that the board preform exhibits a compressed thickness which is less than the desired final thickness of the fiberboard product; and
(b) a curing oven for curing the binder material in the board preform while maintaining substantially the desired final thickness of the fiberboard product.

15. The system of claim 14, wherein said crushing system is spaced upstream of said curing over sufficiently to allow the compressed thickness of the board preform to expand.

16. The system of claim 14, wherein the crushing system includes a nip space defined between a pair of opposed rolls to establish the compressed thickness of the board preform.

17. A system for forming a fiberboard product having a desired final thickness dimension comprising upstream and downstream compression stations which subject a board preform comprised of a mass of inorganic fibers to a respective successive series of compressive pressures, wherein said upstream compression station exerts an upstream compressive pressure on the board preform sufficient to cause the board preform to exhibit an upstream compressed thickness dimension which is less than the final thickness dimension of the fiberboard product, and wherein said downstream compression station exerts a downstream compressive pressure onto the board preform sufficient to cause the board preform to exhibit a downstream compressed thickness dimension which is substantially the same as the final thickness dimension of the fiberboard product.

18. The system of claim 17, wherein said upstream and downstream compression stations are separated by a distance sufficient to allow the upstream compressive pressure to be relaxed and thereby cause the upstream compressed thickness dimension to increase to an intermediate thickness dimension which is less than an initial thickness dimension of the board preform, but is greater than the final thickness dimension of the fiberboard product.

19. The system of claim 17, wherein the board preform includes a heat curable binder material, and wherein the system further comprises a curing oven for curing the binder material downstream of the upstream compression station.

20. The system of claim 19, wherein the downstream compression station is located within the curing oven.

21. The system of claim 19, wherein the upstream compression station includes an opposed pair of rolls which define a nip space establishing the upstream compressed thickness dimension of the board preform.

22. A crusher roll system comprising:
a support frame;
a pair of transversely spaced apart support arms having an upstream end pivotally attached to the support frame and a downstream end;
rearward and forward rolls extending transversely between said pair of support arms at said upstream and downstream ends thereof, respectively;
an endless forming member positioned around and extending between said forward and rearward parallel rolls; and
an adjustable support shaft dependently supporting said downstream ends of said support arms so that adjustable movement of the support shaft causes the support arms to pivot about the upstream ends thereof and thereby adjustably raise or lower the downstream roll.

23. The crusher roll system of claim 22, comprising a pair of said adjustable support shafts.

24. The crusher roll system of claim 23, wherein said adjustable support shafts are threaded.

25. The crusher roll system of claim 24, comprising a motor operatively connected to the threaded support shafts.

26. A method of making a fiberboard product having a final fiber bulk density comprising:
(a) collecting a mass of inorganic fibers to form a board preform having an initial density less than the final density of the fiberboard product;
(b) subjecting the board preform of step (a) to a successive series of compressive pressure conditions which include,
(b1) subjecting the board preform to an upstream compressive pressure which causes the board preform to exhibit a compressed density which is greater than the final density of the fiberboard product, and
(b2) subjecting the board preform to a downstream compressive pressure which causes the board preform to exhibit a density which is substantially the same as the final density of the fiberboard product; and wherein between steps (b1) and (b2) there is practiced the step of,
(b3) removing sufficiently the upstream compressive pressure to cause the compressed density to decrease to an intermediate density which is greater than the initial density of the board preform prior to step (b), but is less than the final density of the fiberboard product.

27. The method of claim 26, wherein step (b) is practiced so as to effect a change in compressive behavior of the board preform to an extent whereby a curve which plots Compressive Pressure (CP) versus density of the board preform is shifted rightward as compared to a CP versus density curve plotted for a nominal board preform not subjected to the series of compressive pressure conditions according to step (b) so that further compressive pressure within a downstream curing oven for the board preform which is subjected to the compressive pressure conditions of step (b) is substantially reduced.

28. A method of making a fiberboard product having a final fiber bulk density comprising:
(a) collecting a mass of inorganic fibers to form a board preform having an initial density less than the final density of the fiberboard product;
(b) subjecting the board preform of step (a) to a successive series of pre-compressive pressure conditions so as to allow the board preform to be capable of further downstream compression to a higher final density, using the same compressive pressure, as compared to the final density obtained for a nominal board preform subjected to said further downstream compression at said compressive pressure, but in the absence of being subjected to the pre-compressive pressure conditions according to step (b).
